(19) United States
(12) Patent Application Publication
(10) Pub. No.: US 2016/0174595 A1
(43) Pub. Date: Jun. 23, 2016

(54) METHOD FOR REDUCTION OF FLYING INSECTS IN LIVESTOCK FEEDS AND FEED SUPPLEMENTS

(71) Applicant: PURINA ANIMAL NUTRITION LLC, Shoreview, MN (US)

(72) Inventors: Bill L. Miller, Labadie, MO (US); Michael S. Burr, Marthasville, MO (US)

(21) Appl. No.: 14/581,676

(22) Filed: Dec. 23, 2014

(51) Int. Cl. A23K 1/08; A23K 1/18

(52) U.S. Cl. CPC A23K 1/08; A23K 1/1813

(57) ABSTRACT

Methods for reducing flying insects from animal feeds or animal feed supplements involve, in a location accessible to flying insects, providing a livestock animal with an animal feed or a liquid supplement and a palatant or a molasses replacement in an amount effective to reduce flying insects from occupying an area on and around the animal feed or the liquid supplement. The palatant or the hydrolyzed whey within the palatant may account for at least about 2 percent of the animal feed or liquid supplement by weight. The hydrolyzed whey may be hydrolyzed whey, whey permeate or delactosed whey permeate containing melanoidins.

### TECHNICAL FIELD

The present disclosure relates to methods of reduction of flying insects, and more particularly to methods of reducing flying insects in livestock operations that use livestock feeds and feed supplements containing palatants by providing a hydrolyzed whey palatant.

### BACKGROUND

House flies (Musca domestica) and stable flies (Stomoxys calcitrans (L.)) breed in livestock operations commonly where moist organic matter is present. These areas include calf hutches; silos; animal stalls and pens; feed preparation and storage areas; water tanks; feed troughs; and in manure handling areas.

Studies have shown that stable flies are among the most damaging arthropod pests of cattle worldwide. In Taylor et al., Economic impact of stable flies (Diptera: Muscidae) on dairy and beef cattle production, 49 J. Med. Entomol., 198-209 (January 2012), yield-loss functions related stable fly infestation levels to cattle productivity to estimate the economic impact of stable flies on cattle production in the United States. Of the four industry sectors were considered: dairy, cow-calf, pastured stockers, and feeder cattle, stable fly infestation levels of individual herds each resulted in loss. For instance, median annual per animal production losses were estimated to be 139 kg of milk for dairy cows, and 6 kg body weight for pre-weanling calves, 26 kg body weight for pastured stockers, and 9 kg body weight for feeder cattle. The 200,000 stable flies emerging from an average sized winter hay feeding site reduce annual milk production of 50 dairy cows by an estimated 890 kg and weight gain of 50 pre-weanling calves, stockers, or feeder cattle by 58, 680, or 84 kg. In 2014 dollars, the value of these losses would be $281, $146, $1,415, or $170, per animal, respectively. The result is hundreds of millions of dollars in loss per year in the U.S. cattle industry alone.

### SUMMARY

Implementations address these problems by providing for the reduction of flying insects in livestock operations that use palatants in livestock feeds and feed supplements by providing a hydrolyzed whey palatant. The palatant may serve as a molasses replacement and may be effective to reduce flying insects on and around the livestock feeds and supplements. The palatant may contain hydrolyzed whey and melanoidins and may be provided from at least about 2 percent of the livestock feed or supplement by weight, which may be an effective amount to reduce a level of flying insects. The palatant may be provided in combination with other insect reduction approaches. In some examples, less toxic insecticides or pesticides may be used in livestock operations when the hydrolyzed whey palatant is used as a replacement for other molasses-based palatants.

According to one implementation, a method of reducing flying insects from animal feeds or animal feed supplements containing a palatant involves, in a location accessible to flying insects, providing a livestock animal with an animal feed or a liquid supplement and a palatant. The palatant includes an acid or an alkaline hydrolyzed whey having a pH of about 4 to about 6, ethanol solubles and melanoidins, and the palatant may be present at a level of at least about 2 percent of the animal feed or liquid supplement by weight, and which is effective to reduce flying insects from occupying an area on and around the animal feed or the liquid supplement.

In certain implementations, the hydrolyzed whey is hydrolyzed whey permeate. In some methods, the flying insects reduced comprise house flies (Musca domestica). In certain embodiments, livestock animals may be a calf, and the animal feed or liquid supplement may be a calf starter coated with the hydrolyzed whey. In addition or alternatively, the livestock animal may be an adult ruminant and the animal feed or liquid supplement may be a liquid supplement adapted for a lick tank, where the liquid supplement comprises the hydrolyzed whey and a secondary source of protein, calcium and phosphorous and sodium in addition to the hydrolyzed whey. In addition or alternatively, the livestock animal may be a ruminant.

In another method of reducing flying insects from animal feeds or animal feed supplements, the method involves in a location accessible to flying insects, providing a livestock animal with an animal feed or a liquid supplement and a molasses replacement, wherein the molasses replacement comprises hydrolyzed whey present in an amount effective to reduce flying insects from occupying an area on and around the animal feed or the liquid supplement.

The hydrolyzed whey may account for at least about 2 percent of the animal feed or liquid supplement by weight. In some methods, the flying insects reduced include house flies (Musca domestica). In certain embodiments, the livestock animal may be a calf and the animal feed or liquid supplement may be a calf starter coated with the hydrolyzed whey, and the calf starter may be textured, e.g. the calf starter may be a pelleted feed combined with corn oats and the palatant as a binder. The hydrolyzed whey may account for at least about 2 percent of the calf starter by weight. In some implementations, the hydrolyzed whey has a pH of about 4 to about 6. In addition or alternatively, the livestock animal may be an adult ruminant and the animal feed or liquid supplement may be a liquid supplement adapted for a lick tank, the liquid supplement comprising the hydrolyzed whey and a secondary source of protein, calcium and phosphorous and sodium in addition to the hydrolyzed whey. The palatant may account for about 20 to 80 percent of the liquid supplement by weight. In addition or alternatively, the livestock animal may be a ruminant. In addition or alternatively, the animal feed or the liquid supplement may be free of molasses. In certain implementations, the reduction in flying insects is at least 40 percent compared to molasses. According to certain implementations, the hydrolyzed whey has a pH of about 4 to about 6. In addition or alternatively, the hydrolyzed whey is derived from acid or alkaline hydrolysis of whey permeate or delactosed whey permeate.

### DETAILED DESCRIPTION

Livestock operations commonly encounter insect populations in an around areas where livestock animals live and feed which can result in decreased animal productivity and monetary loss. Such problems result from the animal expending energy by attempting to alleviate irritation from biting and blood sucking insects. For cows, reduced productivity may involve reduced milk production; for cattle, reduced productivity may involve reduced meat production; for calves, reduced productivity may come in the form of slow growth or increased time to weaning. For instance, shaking-off motions, biting, rubbing and tail switching may all increase heart and respiratory rates of these animals resulting in expended energy that may otherwise be used in milk production or growth. Further, flying insects transmit disease among livestock animals and may be another cause of reduced milk production and growth in ruminants. In addition, producers sometimes become attached to their livestock animals and are desirous of preventing or alleviating livestock animals from experiencing discomfort and sickness.

Consequently, producers often times practice sanitation methods to control fly populations and these practices include: removing manure multiple times per day from livestock enclosures; cleaning spilled feed; maintaining clean and dry bedding; filling low lying areas where water and insect larvae accumulate. Other approaches involve the use of sticky tapes and screens in enclosures for housing livestock. Other traditional methods may use light traps.

Chemical insect control approaches may also be used. Application of insecticides is a primary chemical control approach and may involve applying space sprays, baits, larvicides, residual premise sprays, and animal sprays. Parasitoid release provides some relief for fly populations, in particular, and typically involves the release of parasitoid wasps at the time larvae are maturing into flies. However, heavy reliance on insecticides can destroy parasitoids that may otherwise be an effective means for reducing fly populations and can risk overdose through improper application of insecticides. Consequently, many producers practice a combination of approaches to controlling flies.

While the aforementioned approaches may provide some relief to livestock animals, palatants such as molasses-based palatants serve to attract flying insects. Molasses is a common palatant that is used to make palatable animal feeds from agricultural bi-products which are generally considered not palatable. Consequently, because palatants are often used to cause consumption or to increase consumption by the animals, palatants may be a necessary additive or component of feeds or supplements. This presents a problem because infestations of flying insects in and around animal feeds and supplements containing molasses-based palatants can result in the insects preying on the livestock animals. Producers are faced with the challenge of eliminating palatants at the risk of reduced animal performance from low or non-consumption of feeds or supplements, or providing the animal a diet including these palatants while risking insect infestation and the potential for reduced livestock performance as a result of irritation from bites, energy loss from blood loss as well as the risks of disease transmission and death.

Surprisingly, it has been discovered that flying insect levels may be reduced on and around animal feeds and supplements containing palatants by using a hydrolyzed whey palatant. The palatant of the present disclosure may serve as a replacement for molasses-based palatants and other palatants containing sugar levels of about 35 percent or higher by weight. For instance, as described further, the hydrolyzed whey palatant may be top-dressed onto feeds such as forages, added to a TMR, or be offered free-choice through a lick tank. The palatant of the present disclosure may be fed to ruminants such as dairy cows, heifers, beef cows, feedlot cattle, calves, sheep, deer and goats.

Hydrolyzed Whey Palatants

Hydrolyzed whey palatants of the present disclosure differ from whey, which is a lactose-containing cheese by-product used as an animal feed or animal feed additive. Hydrolyzed whey palatants also differ from whey permeate and delactosed whey permeate. Whey permeate is a lactose-containing product obtained after whey is subjected to an ultrafiltration step in which a substantial amount of protein is removed. Delactosed whey permeate is obtained after whey permeate is subjected to an ultrafiltration step in which some lactose is removed. Other processes for obtaining a delactosed whey include evaporation and reverse osmosis. A significant amount of lactose is still present in the delactosed whey permeate.

The palatants of the present disclosure are hydrolyzed forms of whey, whey permeate or delactosed whey permeate, referred to herein as whey products. Whey products generally contain lactose, protein, calcium, phosphorous and sodium. The lactose present in the whey product is generally hydrolyzed, and hydrolysis of the whey products may be through acid catalyzed hydrolysis or base catalyzed hydrolysis. During hydrolysis, lactose, a disaccharide, is cleaved to form two monosaccharides. Generally, hydrolysis of lactose results in formation of reducing sugars glucose and galactose. In some cases, the hydrolyzed whey products may be processed, e.g., heated, in the presence of amino acids and/or peptides to promote a Maillard reaction in which the reducing sugars react with amino acids and/or proteins to produce a browned liquid. For instance, ethanol solubles such as condensed distillers solubles may be added as a source of amino acids. Ethanol solubles are a by-product from the production of ethanol from animal and vegetable protein containing co-products. Another amino acid source may be lysine, such as crystalline lysine. A further amino acid source may be corn steep liquor derived from high fructose corn syrup production.

Acid Hydrolysis

The lactose in the whey products may be hydrolyzed by acid catalyzed hydrolysis. A variety of acids may be suitable to induce hydrolysis of the lactose and include, for example, phosphoric acid. However any strong acid such as sulfuric or hydrochloric is also suitable. These acids should be non-toxic and compatible for ingestion by animals when the palatant derived from this reaction is used to coat animal feed. The amount of acid used depends on the target pH and the amount of material to be hydrolyzed. Some production of maltose occurs during this process.

After addition of the acid, the whey product is heated. The temperature and the length of heating can vary and may be adjusted to achieve the desired amount of hydrolysis. The whey product is preferably heated to at least about 270° F. More preferably, the whey product is heated to between about 290° F. to about 300° F. Most preferably the whey product is heated to between about 250° F. to about 320° F. In some embodiments, the heating is conducted in a pressure cooker. The whey product is preferably heated under pressure. The amount of time required for acid hydrolysis depends on the processing temperature, as pressure increases time may be decreased. The whey product is preferably heated for at least about 3 minutes. Most preferably, the whey product is heated for about 10 minutes.

In the present disclosure, an amino acid or protein source may be added following acid hydrolysis of the whey product. The pH of the hydrolyzed whey product may be adjusted upward to between about 4.0 and about 6.0, more preferably to about 5.0. The pH is generally adjusted by the addition of sodium hydroxide although other suitable bases may also be used. The whey product may be heated further to drive off more of the moisture until the desired moisture level or consistency is attained and a brown liquid is formed.

Alkaline Hydrolysis

In alkaline hydrolysis, the whey product is generally mixed with the amino acid or protein source. The pH of the whey product may be adjusted to between about pH 8.0 and about pH 11.0. Most preferably, the pH of the whey product is adjusted to about 10.0. The pH may be adjusted by the addition of sodium hydroxide, although other suitable bases may be used.

After adjusting the pH, the whey product is heated. The temperature and the length of heating can vary and may be adjusted to achieve the desired amount of hydrolysis. The whey product is preferably heated to at least about 270° F. More preferably, the whey product is heated to between about 290° F. to about 300° F. Most preferably the whey product is heated to between about 250° F. to about 320° F. In some embodiments, the heating is conducted in a pressure cooker. In alternative embodiments, the heating is conducted under a vacuum. The heating can be conducted using a continuous flow coil. The whey product is preferably heated for at least about 7 minutes at 295° F. or higher. Most preferably, the whey product is heated for about 10 minutes.

After alkaline hydrolysis, the pH of the liquid may be adjusted to between about 4.0 and about 8.0, more preferably to about 7.0. Any suitable acid may be used to adjust the pH. For instance, phosphoric acid may be used to adjust the pH. The liquid may be heated further to drive off more of the moisture until the desired moisture level or consistency is attained as described above for acid hydrolysis and a brown liquid is formed.

The hydrolyzed whey palatants in combination with ethanol solubles or other sources of amino acids may therefore be provided to livestock animals as a palatant, while at the same time, may serve to attract less flying insects compared to other palatants.

Maillard Reaction

The Maillard reaction is a complex chemical reaction between an amino acid and a reducing sugar, such as glucose and galactose produced from hydrolysis. The reaction is commonly in the presence of heat, which may be accelerated in an alkaline environment. The Maillard reaction results in non-enzymatic browning of the product. This is different from caramelization in that the Maillard reaction utilizes amino acids whereas caramelization involves oxidation of sugars. In other words, caramelization does not require the presence of amino acids. While the Maillard reaction results in formation of a number of flavor compounds, a portion of the Maillard reaction product are melanoidins, which are brown nitrogenous polymers and copolymers. The melanoidins may impart a variety of flavors such as bitter, burnt, roasted, malty, caramel and crust-like.

According to the present disclosure, the elevated temperature and optionally pressure conditions during or after acid hydrolysis and alkaline hydrolysis may promote the Maillard reaction, but the Maillard reaction may result when amino acids and reducing sugars are present in an admixture. When ethanol solubles and other sources of amino acids are used, it has been discovered the Maillard reaction products in the hydrolyzed whey permeate provide a sweet flavor that is palatable to livestock animals. The hydrolyzed whey palatants containing melanoidins derived from a Maillard reaction of whey products in combination with ethanol solubles and other sources of amino acids may therefore be provided to livestock animals as a palatant, while at the same time, may serve to attract less flying insects compared to other palatants.

In some embodiments, the lactose in the whey product is hydrolyzed, amino acids are added, and the mixture is heated to promote the Maillard reaction. This approach may be followed, for instance, when whey products undergo acid hydrolysis. In alternative embodiments, the whey product is combined with amino acids, prior to hydrolysis, and then the combination is heated to hydrolyze lactose and promote the Maillard reaction. This approach may be followed, for instance, when whey products undergo alkaline hydrolysis.

After the Maillard reaction, the pH of the mixture may be adjusted, preferably, to about 5.0 in an acidic hydrolysis and to about 8.0 in an alkaline hydrolysis. The mixture may be heated under vacuum again to reduce the moisture content to the desired level. The hydrolyzed whey palatant may be stored in a container until applied to animal feed. Alternatively, the hydrolyzed liquid sweetener may be combined with an oil, preferably soy oil, before being applied to animal feed.

Production of the palatant may involve heating until the desired moisture content is reached.

Composition of Hydrolyzed Whey Palatants

Hydrolyzed whey palatants may contain an admixture of hydrolyzed whey product(s), a source of amino acids, lactose, other sugars, melanoidins, additives and moisture.

Hydrolyzed whey product may be present in the palatant at about 60 to about 90 percent by weight of the palatant, and preferably about 65 to about 85 percent by weight of the palatant. The hydrolyzed whey product may preferably be hydrolyzed whey permeate or delactosed whey permeate. The hydrolyzed whey product may include ethanol solubles, lactose, other sugars (e.g., glucose, galactose, fructose, sucrose and/or maltose) and moisture.

The source of amino acids and/or peptides to promote a Maillard reaction may include ethanol solubles, which may be present in the palatant may be about 10 to about 25 percent by weight, and preferably about 10 to about 15 percent by weight of the palatant. Alternatively, ethanol solubles present in the hydrolyzed whey product may be at about 10 to about 25 percent by weight, and preferably about 10 to about 15 percent by weight. The ethanol solubles are preferably condensed distillers solids derived from corn, wheat and/or rye. Other sources of amino acids may include lysine such as crystallized lysine and corn steep liquor, for instance, derived from the production of high fructose corn syrup.

Lactose from the hydrolyzed whey product may be present in the palatant at about 2 to about 20 percent by weight, or preferably about 2 to about 15 percent , 2 to about 10 percent by weight of the palatant. Alternatively, lactose present in the hydrolyzed whey product may be about 3 to about 21 percent by weight.

Glucose from the hydrolyzed lactose may be present in the palatants at about 0.5 to about 10 percent by weight, and preferably about 0.5 to about 8 percent by weight of the palatant or the hydrolyzed whey product. Other monosaccharaides, such as galactose and fructose, and disaccharides, such as sucrose and maltose, may also be present in the palatant and hydrolyzed whey product. Fructose may be present at about 0.1-1.0 percent by weight of the palatant or the hydrolyzed whey product. Sucrose may be present at about 0.1 to 1.0 percent by weight of the palatant or the hydrolyzed whey product. Maltose may be present at 0.1 to 13 percent by weight of the palatant or the hydrolyzed whey product. As provided, melanoidins may be present in the palatant composition where the Maillard reaction follows hydrolysis or proceeds concurrently with hydrolysis.

Additives present in the palatant may include: clay, phosphoric acid, soy oil, propionic acid, and tetrasodium pyrophosphate (TSPP). Oil may be present at about 10 percent by weight of the palatant. Other additives may be present at about 0.1 to 2.0 percent by weight of the palatant.

Moisture in the palatant may range from about 20 to about 50 percent by weight, about 25 to about 40 percent by weight, and preferably about 30 to about 40 percent by weight of the palatant. In some implementations, moisture may be derived from both moisture contained in the hydrolyzed whey product as well as added water.

The pH of the palatant may be about 5.0 to about 8.0, and preferably about 4 to about 6, and the target pH may be reached as a result of pH adjustment. Accordingly, the palatant may contain a pH adjustment component at about 0.1 to about 2.0 percent by weight of the palatant. For instance, phosphoric acid or sodium hydroxide, or a portion of their constituents, may be present when used to adjust the pH of the palatant upward or downward.

Because the palatants of the present disclosure are a replacement for molasses, the palatant may be free of molasses.

Methods of using Hydrolyzed Whey Palatants

According to the present disclosure, areas accessible to flying insects where animals are fed may have a reduced insect level when the hydrolyzed whey palatant is used in connection with animal feeds or animal feed supplements. These areas may include confined settings such as barns and feed lots; semi-confined settings such as farms and ranges; and open settings such as fields and prairies. In each of these settings, a palatant may be required to cause or encourage the animal to eat, while offering the benefits associated with reduced levels of flying insects.

Animal feeds that may be combined with the hydrolyzed whey palatants can include, for example, pelleted feeds; grains such as corn, oats, sunflower seeds and derivatives therefrom; and forages such as hay, haylage and silage. In some implementations the animal feed is a calf starter. For instance, the calf starter may be a pelleted feed coated with the hydrolyzed whey palatant. Some calf starters may be textured starter feeds. Textured feeds are generally starter pellets mixed with corn and oats and the hydrolyzed whey palatant, which may bind the pellets, corn and oats together. The hydrolyzed whey palatants may be used as a coating on the animal feed through, for instance, top-dressing. In addition or alternatively, the palatant may be added to a total mixed ration (TMR) that includes, for instance, grains, formula feeds and forage (e.g., hay and silage). Further, the palatant may be offered free-choice.

In free choice applications, the hydrolyzed whey palatants may be used in combination with a liquid feed supplement. For ruminants such as cattle on pasture or in feedlots, liquid supplements may be delivered to the animal via lick tanks. The ruminant is attracted to the lick tank due to a palatant provided within the liquid supplement. In prior approaches, molasses was used as a palatant to encourage animals to ingest the liquid feed supplement, which resulted in increased levels of flying insects.

The palatants or hydrolyzed whey products of the present disclosure may be applied to or incorporated in animal feeds, and may account for at least about 2 percent, about 2 to about 10 percent, about 2 to about 5 percent and/or about 5 to 10 percent by weight of the animal feed. At these levels, the hydrolyzed whey palatants or hydrolyzed whey contained in the palatant may provide palatability and a consistency suited for use in combination with animal feeds that may otherwise not be palatable, while at the same time being present in an amount that is effective at controlling or reducing flying insects on and around the animal feed.

According to the present disclosure, the hydrolyzed whey palatants may serve as a replacement for molasses and be combined with the liquid feed supplement prior to or in connection with depositing the liquid feed supplement in the lick tank. Liquid forms of feed supplements often include a combination of vitamins, minerals and nutrients to balance the target animal's diet. Accordingly, in addition to the hydrolyzed whey palatant, the liquid feed supplement may contain crude protein at about 30 to 60 percent, moisture, and vitamins and minerals such as calcium, phosphorous, sulfur, potassium, magnesium, cobalt, copper, iron, manganese, zinc, iodine, vitamin A, vitamin D, vitamin E. In some implementations, the liquid feed supplement containing the hydrolyzed whey palatant may contain about 40 to 70 percent dry matter with the balance moisture, e.g., about 30 to 60 percent moisture.

The palatants of the present disclosure may form about 20 to 80, about 20 to 60, or about 40 to 80 percent of the liquid feed supplement by weight. For instance, liquid feed supplements directed for feedlot cattle may contain the palatant at about 20 to about 60 percent of the liquid feed supplement by weight. For liquid feed supplements directed for grass cattle, the palatant may account for about 40 to about 80 percent of the liquid feed supplement by weight. In some implementations, the hydrolyzed whey may account for about 15 to 65 percent, about 15 to 55 or about 40 to 65 percent by weight of the liquid feed supplement. At these levels, the hydrolyzed whey palatants or hydrolyzed whey contained in the palatant may provide palatability and a consistency suited for use in combination with liquid feed supplements that may otherwise not be palatable, while at the same time being in present in an amount that is effective at controlling or reducing flying insects on and around the liquid feed supplement.

### EXAMPLES

The following non-limiting examples provide approaches for reducing or controlling flying insects on and around hydrolyzed whey palatants as a raw ingredient and when used as a coating on animal feed.

In the Examples below, statistical analysis was completed for parameters studied. A P value of 0.10 means that 10 times out of 100 the results can be explained by factors other than the providing of hydrolyzed whey palatants of sorbitol versus the providing of molasses. For purposes of comparing data in this document, P values of 0.05, or lower, are considered statistically significant. Thus, where a P value of 0.05 or less is returned for particular results, it is assumed that the differing results may be explained by the test regimen, i.e.: the providing hydrolyzed whey palatants as opposed to molasses.

### Example 1

Flying insect-heavy areas were used to test the effectiveness of the palatant in reducing or controlling flying insects. These areas included a farm with a goat barn, dairy area and horse barn. The hydrolyzed whey palatant was obtained from alkaline hydrolysis (pH 10) under high temperatures (e.g., 295° F.) and pressure (e.g., 30 to 35 psi) and contained about 85 percent hydrolyzed whey permeate, about 14 percent condensed distillers solubles, sodium hydroxide and melanoidins. Molasses or a hydrolyzed whey palatant using whey permeate as the whey product were placed on separate paper plates in the same amounts and the paper plates were placed side-by-side in these areas and six grams of one sweetener type was spread on a plate. A camera was setup on a tripod and remote system and treatments were allowed to sit for a minimum of 10 minutes. A picture was taken of both plates simultaneously from a remote location so as not to disturb the flying insects. After the picture was taken, flies were disturbed and another picture taken 10 minutes later. This cycle was repeated for a total of five pictures for each of the three testing days. The results of Example 1 are provided in Table 1.

TABLE 1

| Treatment | Estimate | Standard Error | Mean |
|---|---|---|---|
| Molasses | 3.78 | 0.61 | 3.78 |
| Hydrolyzed whey palatant | 1.38 | 0.61 | 1.38 |

The results of Table 1 show the hydrolyzed whey palatant reduced the level of flying insects (house flies) by a statistically significant amount (P<0.05) compared to molasses. In particular, the reduction in flying insects was at least 50 percent, and more particularly at least 60 percent using the hydrolyzed whey palatant compared to molasses.

### Example 2

In view of the positive results of Example 1, the hydrolyzed whey palatant was compared against molasses when used as an additive on animal feed. Treatments containing coated feed (10 grams) with 2 or 5 percent molasses or the hydrolyzed whey palatant were placed in the insect heavy areas of Example 1. As no interactions were detected, data were summarized by pooling the two levels of each palatant into a single mean. Treatments were again placed in close proximity in each of these areas. Pictures were taken in the same manner as Example 1 but over the course of one day in which five test photos were taken. The results of Example 2 are provided in Table 2.

TABLE 2

| Treatment | Estimate | Standard Error | Mean |
|---|---|---|---|
| Feed + Molasses | 2.69 | 0.47 | 2.69 |
| Feed + Hydrolyzed whey | 1.28 | 0.47 | 1.28 |
| palatant | | | |

The results of Table 2 show the hydrolyzed whey palatant when applied on feed reduced the level of flying insects (house flies) by a statistically significant amount (P<0.05) compared to the use of molasses on animal feed. In particular, the reduction in flying insects was at least 40 percent, and more particularly at least 50 percent in areas on and around the animal feed using the hydrolyzed whey palatant and feed combination as compared to the molasses and feed combination.

Examples 1 and 2 illustrate that hydrolyzed whey palatants are effective to reduce flying insects in areas where the palatant is present, particularly in areas where animal feed or liquid supplements are used in combination with palatants. The reduction is at least 40 percent as compared to molasses palatants, but may even be at least a 50 percent or a 60 percent reduction. This means the hydrolyzed whey palatants may be used as one method for pest reduction, which may be used alone or in combination with other pest control methods. Moreover, with the reduction of flying insects due to the use of a hydrolyzed whey palatant, less toxic or a reduced amount of pesticides may be used in and around livestock animals.

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. A method of reducing flying insects from animal feeds or animal feed supplements containing a palatant, the method comprising:
in a location accessible to flying insects, providing a livestock animal with an animal feed or a liquid supplement and a palatant, wherein the palatant comprises an acid or an alkaline hydrolyzed whey having a pH of about 4 to about 6, ethanol solubles and melanoldins,
wherein the palatant accounts for at least about 2 percent of the animal feed or animal feed supplement by weight, and
wherein the palatant is effective to reduce flying insects from occupying an area on and around the animal feed or the liquid supplement.

2. The method of claim 1, wherein the hydrolyzed whey is hydrolyzed whey permeate.

3. The method of claim 1, wherein the flying insects reduced comprise house flies (Musca domestica).

4. The method of claim 1, wherein the livestock animal is a calf and the animal feed or liquid supplement is a calf starter coated with the hydrolyzed whey.

5. The method of claim 1, wherein the livestock animal is an adult ruminant and the animal feed or liquid supplement is a liquid supplement adapted for a lick tank, the liquid supplement comprising the hydrolyzed whey and a secondary source of protein and calcium in addition to the hydrolyzed whey.

6. The method of claim 1, wherein the livestock animal is a ruminant.

7. A method of reducing flying insects from animal feeds or animal feed supplements, the method comprising:
in a location accessible to flying insects, providing a livestock animal with an animal feed or a liquid supplement and a molasses replacement, wherein the molasses replacement comprises hydrolyzed whey and melanoidins,
wherein the molasses replacement is present in an amount effective to reduce flying insects from occupying an area on and around the animal feed or the liquid supplement.

8. The method of claim 7, wherein the hydrolyzed whey accounts for at least about 2 percent of the animal feed or liquid supplement by weight.

9. The method of claim 7, wherein the flying insects reduced comprise house flies (Musca domestica).

10. The method of claim 7, wherein the livestock animal is a calf and the animal feed or liquid supplement is a calf starter coated with the hydrolyzed whey.

11. The method of claim 10, wherein the calf starter is textured.

12. The method of claim 10, wherein the hydrolyzed whey accounts for about 2 percent to about 5 percent of the calf starter by weight.

13. The method of claim 12, wherein the hydrolyzed whey has a pH of about 4 to about 6.

14. The method of claim 7, wherein the livestock animal is an adult ruminant and the animal feed or liquid supplement is a liquid supplement adapted for a lick tank, the liquid supplement comprising the hydrolyzed whey and a secondary source of protein and calcium in addition to the hydrolyzed whey.

15. The method of claim 14, wherein the molasses replacement accounts for about 20 to 80 percent of the liquid supplement by weight.

16. The method of claim 7, wherein the livestock animal is a ruminant.

17. The method of claim 7, wherein the animal feed or the liquid supplement is free of molasses.

18. The method of claim 7, wherein the reduction in flying insects is at least 40 percent compared to molasses.

19. The method of claim 17, wherein the hydrolyzed whey has a pH of about 4 to about 6.

20. The method of claim 18, wherein the hydrolyzed whey is derived from acid or alkaline hydrolysis of whey permeate or delactosed whey permeate.
